(19) United States
(12) Patent Application Publication
(10) Pub. No.: US 2008/0084707 A1
(43) Pub. Date: Apr. 10, 2008

(54) Backlight for avionics light emitting diode display

(75) Inventors: Theodore Richard Blumstein, Vero Beach, FL (US); Geoffrey Allen Shapiro, Cedar Rapids, IA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Avidyne Corporation, Lincoln, MA (US)

(21) Appl. No.: 11/649,705

(22) Filed: Jan. 4, 2007

Related U.S. Application Data
(60) Provisional application No. 60/850,213, filed on Oct. 6, 2006.

(51) Int. Cl. F21V 8/00; G09G 3/34; H05B 37/02

(52) U.S. Cl. 362/606; 315/294; 315/313; 345/84; 362/343

(57) ABSTRACT

A display panel includes a light guide with a housing that has at least one elliptical shaped surface including a first focal point and a second focal point disposed along a major longitudinal axis. The display panel also has at least one light emitting diode being positioned in proximity to the first focal point and a reflector associated with an inner surface of the housing. The display panel further includes an optical film positioned in proximity to an outlet of the housing. The outlet communicates with the display screen. Light that is emitted from the at least one light emitting diode passes through the first focal point and is reflected to the second focal point. The light from the second focal point is then directed through the optical film so that the light is diffused to the display screen. Method and apparatus for the display panel also include devices for increasing an intensity of one of a first and a second banks of light emitting diodes if an overall intensity of the display is detected below a set threshold, and devices for synchronizing the illumination of banks of light emitting diodes so no two banks of light emitting diodes are illuminated during the same time period. The display avoids current surges and generated magnetic fields associated with illuminating banks during the same time interval.

### CROSS REFERENCE TO RELATED PATENT APPLICATIONS

The instant patent application claims the benefit of U.S. Provisional Patent Application No. 60/850,213, filed on Oct. 6, 2006, which is herein incorporated by reference in its entirety.

### BACKGROUND OF THE INVENTION

Electronic display panels are known in the art. Generally, the display panels include back lighting features or backlit light emitting diodes that are disposed in a number of banks of light emitting diodes behind a display screen. Generally in these prior art display systems, all of the banks are illuminated at the same time interval. This results in a large amount of current that the control circuit has to supply in order to illuminate each bank in a simultaneous fashion.

Generally, these prior art displays operate by illuminating the display at a frequency of over 60 Hertz so the display appears to be constantly illuminated over the entire time period. However, these prior art systems include a large and costly amount of shielding. The shielding operates to shield the user and other instruments from the magnetic field that is generated each time each of the banks is illuminated at the same time. Moreover, costly capacitor components must be used in order to appropriately store energy for each cycle due to the amount of current involved with each cycle which can increase the overall manufacturing cost for the unit. Also, such prior art display systems need maintenance to replace failed bulbs or failed light emitting diodes when the product life of the bulb expires.

Accordingly, there is a need in the art for a backlighting system for an avionics display system with a design that can efficiently use the available lighting components in a productive manner and that does not need such expensive capacitor components or other costly magnetic field shielding to safely achieve a desired level of luminance or brightness. There is a need in the art for a backlighting system for an avionics display that is lightweight and still may achieve a desired level of luminance or brightness. There is a need in the art for a backlighting system for an avionics system that achieves a desired level of brightness, and generates a relatively lower magnetic field as compared to other prior art systems.

### SUMMARY OF THE INVENTION

According to a first embodiment of the present disclosure, there is provided a display panel. The display panel includes a light guide with a housing having at least one elliptically shaped surface with a first focal point and a second focal point disposed along a major longitudinal axis. The display panel further includes at least one light emitting diode that is positioned in proximity to the first focal point and a reflector associated with the inner surface of the housing. The display panel also includes an optical film positioned in proximity to an outlet of the housing having the elliptical shaped surface. The outlet communicates with the display panel and light emitted from the light emitting diode passes through the first focal point and is reflected by the reflector to the second focal point and directed through the optical film and diffused to the display panel.

In another aspect, the present disclosure includes a plurality of light emitting diodes. In yet another aspect, the plurality of light emitting diodes is disposed in a bank and the bank is at proximity to the first focal point. In another aspect, the at least one light emitting diode is at the first focal point. In another embodiment, the reflector is directly connected to the inner surface or the reflector is deposited on the inner surface of the housing.

In another embodiment of the present invention, the optical film can be a diffuser and in yet a further aspect the second focal point directs light to an interior of the light guide and the light is collimated and directed to the outlet. In another embodiment of the present disclosure, the reflector is a specular reflector. The specular reflector is disposed on the inner surface. In still another embodiment of the present disclosure, the at least one light emitting diode emits white light. In a further embodiment of the present disclosure, the reflector is plated to the inner surface. In another embodiment of the present disclosure, the light originates from the first focal point and is directed to the second focal point and contacts a lateral surface of the light guide. The light reflects off the lateral surface to enter the diffuser at about ninety degrees.

In another aspect of the present disclosure, the light guide is configured as a backlight for a liquid crystal display. In yet a further aspect of the present invention, the housing comprises a reflective inner surface. In yet another aspect, the reflector comprises chrome. In still another embodiment, the light guide may have multiple optical films associated with the diffuser with a first enhancing a brightness and a second film returning improperly oriented light to an interior of the light guide.

According to a second embodiment of the present disclosure, there is provided a light guide. The light guide includes a housing with an elliptical shaped inner surface that has a first focal point and a second focal point disposed along a major longitudinal axis of the light guide. The housing with the elliptical shaped surface includes a reflective surface associated with the elliptical shaped inner surface of the housing. The light guide also includes a diffuser. The diffuser is positioned in proximity to an outlet of the housing. Light either reflected or originating near the first focal point is directed to the second focal point and directed to the outlet.

In another aspect of the present disclosure, the light guide further comprises a light emitting diode that is disposed near the first focal point. In yet another aspect, the light guide further comprises a plurality of light emitting diodes that are disposed in a series of banks. The series of banks are at or near the first focal point.

In one aspect, the reflective surface comprises a reflector that is directly connected to an inner surface. In another embodiment of the present disclosure, the reflective surface is deposited on the inner surface. In yet another embodiment of the present disclosure, the diffuser is an optical film that is connected to the outlet. In yet a further aspect of the present disclosure, the second focal point directs light to a second reflective surface configured to orient the light at about ninety degrees relative to the outlet.

In yet a further aspect of the present disclosure, the reflective surface is a specular reflector. In yet a further aspect of the present disclosure, the at least one light emitting diodes emits white light. The reflective surface may further be plated to the inner surface.

In a further aspect of the present disclosure, the light guide can further comprise a liquid crystal display located at the outlet. Alternatively, the reflective surface comprises chrome. In an alternative embodiment, the light guide further comprises at least two banks of light emitting diodes. At least one of the banks of light emitting diodes can be under the first focal point. Alternatively, the light guide comprises at least three banks of light emitting diodes, or at least four banks of light emitting diodes, or more with the banks located at the first focal point.

According to another embodiment of the present disclosure, there is provided a method of controlling a plurality of light emitting diodes that is configured for reducing current surges in a display. The method comprises illuminating a first bank of light emitting diodes for a first time period and at the conclusion of that first time period terminating illumination of the first bank of light emitting diodes. The method also includes illuminating a second bank of light emitting diodes for a respective second time period. At the conclusion of the respective second time period, the method terminates illumination of the second bank of light emitting diodes.

The method also has a step of illuminating a third bank of light emitting diodes for a respective third time period, and at the conclusion of the respective third time period terminating illumination to the third bank of light emitting diodes. The method also has the step of illuminating a fourth bank of light emitting diodes for a respective fourth time period and at the conclusion of the respective fourth time period terminating illumination of the fourth bank of light emitting diodes. The method also has the steps of repeating illumination of the first through fourth banks and synchronizing the first bank through fourth banks so no two banks of light emitting diodes are illuminated during the same time period, (i.e., maximum time period).

In another embodiment, the method further comprises switching consecutively the first through fourth banks from an illuminated state to non-illuminated state at a frequency higher than a human eye can detect. The switching can be suitable so that the first through fourth banks appear to be constantly illuminated. In another embodiment of the present disclosure, the method further comprises controlling a maximum current surge by illuminating the first through fourth banks so that the current is below a maximum current surge with the maximum current surge being an instance where the first through fourth banks are illuminated during the same phases and during the same time period. In another aspect, the method further comprises illuminating white light.

According to another embodiment of the present disclosure, there is provided an apparatus for controlling a plurality of light emitting diodes. The apparatus includes a logic unit for controlling illumination of a first bank of light emitting diodes and for a predetermined duration. The apparatus also has a switch coupled to the logic unit and is configured to terminate illumination to the first bank of light emitting diodes at the conclusion of the predetermined duration.

The apparatus also includes that the logic unit is configured to control illumination of a second bank of light emitting diodes by controlling the switch with the switch configured for switching on the second bank for a second duration at the conclusion of the first duration.

The apparatus also has that the logic unit times the illumination of the first and second banks so that the first and second banks are synchronized and so neither bank of light emitting diodes is illuminated during the same phase, (i.e., moment in time). In one aspect, the logic unit is a controller.

In another aspect, the switch comprises a field effect transistor that is configured to receive a signal from the controller and configured to illuminate and terminate the illumination of the first and second banks of light emitting diodes.

According to another aspect of the present disclosure, there is provided a method for controlling a display illumination. The method illuminates the first illumination device for a first predetermined duration and at the conclusion of the duration terminating illumination. The method also has the steps of illuminating a second illumination device for another predetermined duration at the conclusion of the first duration and timing the illumination of the first and second illumination devices. The timing is appropriate so that neither device is illuminated during the same predetermined illumination period, (i.e., at a same time). The method sequentially repeats illuminating the first and second illumination devices.

The method also has the steps of determining an intensity of the first and second illumination devices and comparing the determined intensity to a threshold. The method then increases the intensity of one of the illumination devices if the determined intensity is below the threshold. In another embodiment of the present disclosure, the method further comprises illuminating the first and second banks of light emitting diodes as the respective first and second illumination devices. In another aspect, the method further comprises determining the intensity of the first and second illumination device by determining whether the first and second illumination device is functioning. In yet another aspect, the method further comprises terminating power to one of the first and the second illumination devices if the determined intensity is below the threshold.

In another aspect, the method further comprises sequentially repeating illuminating the first and the second illumination devices at a frequency that is higher than the human eye can detect with repetition being suitable so that the first and second illumination devices appear to be constantly illuminated.

According to yet another embodiment of the present disclosure there is provided an apparatus. The apparatus includes a first illumination device and a second illumination device. The apparatus also includes a logic unit connected to a switch that is configured for illuminating the first illumination device for a first predetermined duration and that the conclusion of the first duration terminating illumination of the first illumination device.

The apparatus further includes a logic unit that is further configured to illuminate the second illumination device for another predetermined duration at the conclusion of the first duration. The logic unit times the illumination of the first and second illumination devices so that the first and second illumination devices are synchronized to sequentially illuminate so that neither illumination device is illuminated during the same predetermined duration (i.e., at the same moment in time). The logic unit sequentially repeats illuminating the first and second illumination devices.

The logic unit is connected to a first element. The first element is connected to at least one of the first and second illumination devices. The logic unit develops a signal from the first element to determine intensity of the first and second illumination devices. The logic unit compares the determined intensity to a threshold stored in a memory. The logic unit is connected to a power supply, and is configured to increase intensity of at least one of the first and second illumination devices if the determined intensity is below the threshold.

In another aspect, the apparatus further comprises a second element connected to the other of the first and second illumination devices. The logic unit develops a signal from the second element to determine the intensity of the first and second illumination devices. In yet a further aspect, the apparatus includes that the first illumination device is at least one light emitting diode. In yet another aspect, the apparatus includes that the second illumination device is at least one light emitting diode. In another aspect of the present disclosure, the apparatus includes that the logic unit comprises a controller.

In a further aspect, the apparatus includes that the first element is a resistor. In another aspect, the second element is a resistor.

In a further aspect of the present disclosure, the apparatus includes that the threshold is an intensity that is in a range that includes 800 to 1,000 Nits of brightness. In a further aspect of the present disclosure, the threshold is an intensity that is in a range that includes 400 to 500 Nits of brightness.

According to yet another embodiment of the present disclosure there is provided an apparatus that has a first and second illumination device. The apparatus also includes a logic unit connected to the first illumination device and the second illumination device. The logic unit is further coupled to a first element.

The first element is connected to at least one of the first and second illumination devices. The logic unit develops a signal from the first element to determine an intensity of the first and second illumination devices. The logic unit is connected to a power supply and is configured to increase intensity of at least one of the first and second illumination devices if the apparatus determines that the intensity is below the threshold. In another embodiment, the present backlight includes banks of light emitting diodes that provide for an inherent redundancy.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of avionics display having a backlight feature with a light guide according to the present invention;

FIG. 2 is a cut away perspective view of the avionics displays with the light guide of FIG. 1;

FIG. 3 is an enlarged view of the light guide of FIG. 2 showing a light emitting diode and a number of optical films;

FIG. 4 is a side view of an alternative embodiment of the light guide of the present disclosure with the light guide having a reflector;

FIG. 5 is a side view of still another alternative embodiment of the light guide having an inner reflective surface;

FIG. 6 is a cut away perspective view of the display with the light guide and illustrating an illumination ray path through the light guide and to the display panel;

FIG. 7 is a simplified electrical schematic diagram of a control circuit according to another embodiment of the present disclosure having a number of elements that allow a controller to determine whether a particular light emitting diode bank is illuminated or non-illuminated;

FIG. 8A is an electrical schematic diagram of a control circuit according to another embodiment of the present disclosure having a number of elements that allow a controller to determine whether a particular light emitting diode bank is illuminated or non-illuminated and having a device for synchronizing the illumination phases of the banks of light emitting diodes so no two banks are illuminated during the same phase;

FIG. 8B is an electrical schematic diagram of another embodiment of the control circuit of FIG. 8A according to the present disclosure;

FIG. 9 is a number of plots of a current over time for four illumination phases of a number of banks of light emitting diodes of the present disclosure and as compared to a plot of a current consumption over time;

FIG. 10 is a number of plots of an amount of current per unit time having an alternative duty cycle relative to the embodiment of FIG. 9;

FIG. 11 shows a method for determining whether a bank of light emitting diodes is illuminated and for compensating for the non-illuminated bank; and

FIG. 12 shows a method of timing the illumination of a number of banks of light emitting diodes so the banks are out of phase relative to one another to reduce a current surge.

### DETAILED DESCRIPTION OF THE INVENTION

A description of preferred embodiments of the invention follows.

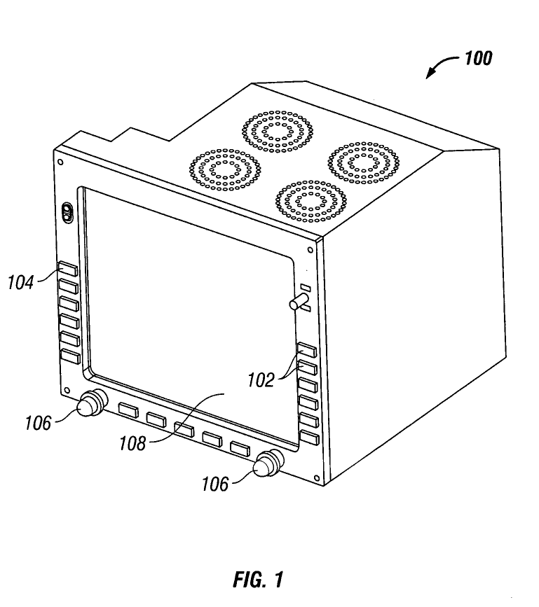

Turning to FIG. 1, there is shown a display panel 100. The display panel 100 is preferably configured as a display panel for an avionics display for an aircraft; however, the present disclosure is not limited to an avionics display for an aircraft, and may be configured to be used with any transportation device, or may be configured for use with any device using a backlight display.

FIG. 1 is a perspective view of a display system 100 including a plurality of push buttons 102, 104. The display system 100 also includes adjustment knobs 106 and a screen 108. The display system 100 includes a display which is an electronic device such as a Cathode Ray Tube (CRT) or liquid crystal display (LCD)-based or gas plasma-based flat panel display that temporarily presents information in visual form. The information is displayed on the screen 108 of the display system 100, that is, a surface of the display system on which the information appears. In display systems, the internal representation of a screen of information displayed on the screen is typically referred to as a page. A page is a portion of display memory that contains one complete full-screen image. Each push button 102, 104 is a small actuator that when pushed closes a respective electric circuit. The closing of the electric circuit denotes selection of a function that is mapped to the push button 102, 104. One may desire pages to be backlit under certain conditions which may occur automatically or by turning knobs 106, or by depressing buttons 102, 104.

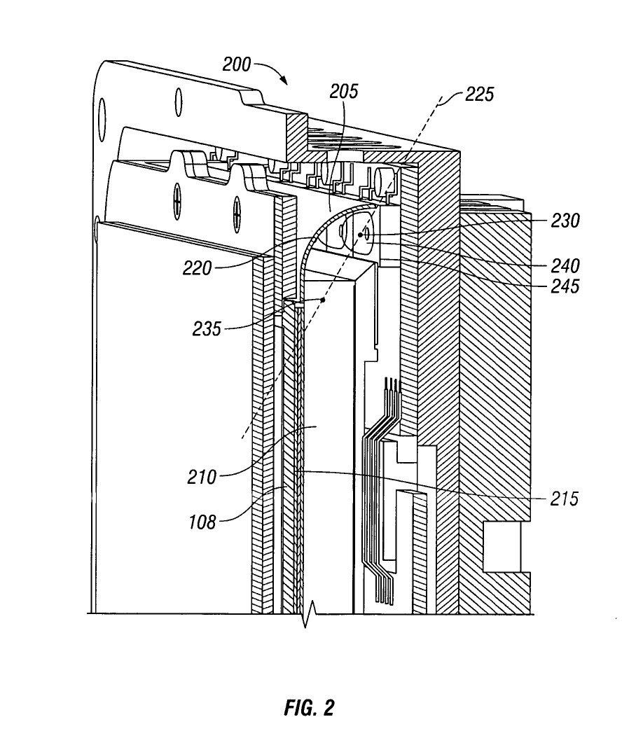

In one embodiment, the display screen 108 includes a backlight feature. The backlight feature includes an illumination by an illumination device that is located behind the display screen 108 in a light guide 200 (FIG. 2). An illuminable element (not shown) is seated in the light guide 200. The light can be provided by a light emitting diode (LED). The illumination of each illuminable element is separately controlled, or may be controlled in a number of banks of illuminable elements. In alternate embodiments, other lighting techniques well known to those skilled in the art can be used for the illuminable element. For example, the illuminable element can include other devices such as light bulbs, light emitting diodes, or another combination of illumination devices.

Referring now to FIG. 2, the interior contents of the light guide 200 will be discussed. The light guide 200 preferably has a resilient housing 205. The resilient housing 205 has a shape that preferably directs all of the light generated in the interior 210 of the housing 205 to a rear or proximal portion 215 of the display screen 108. In one embodiment, the housing 205 is elliptically shaped. In another embodiment, the housing 205 may have an elliptical surface or include side walls that include a curvature so that when taken on at least one plane the curvature is elliptical. The housing 205 preferably includes an elliptically curved section 220. In this aspect, the housing 205 includes a major axis 225 shown in dotted lines and a first focal point 230 and a second focal point 235. It is appreciated that due to the shape of an ellipse a sum of the distances along the elliptically shaped curved section 220 measured to the first focal point 230 and measured the second focal point 235 is constant.

The light guide 200 further includes a number of banks of light emitting diodes 240 along a top edge 245 of the light guide 200. In one embodiment, each bank of light emitting diodes 240 includes six light emitting diodes. In one embodiment, the light guide 200 is configured to include four banks 240 with each bank adjacent to one another and positioned as shown along edge 245. In one embodiment, the light emitting diodes 240 are held in place using a suitable tab or fastener. As shown in FIG. 2, the display 100 is configured to a single display screen 108; however, it should be appreciated that the display 100 may be configured to have any number of screens that is needed or contemplated depending on the application. Moreover, it should be appreciated that some display screens 108 will require a backlighting feature, while others do not require the backlight feature.

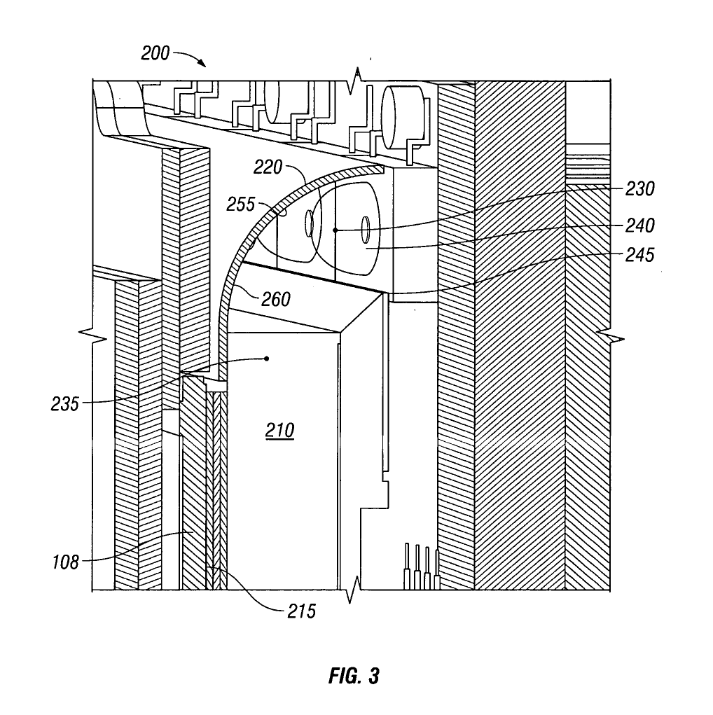

Turning now to FIG. 3, there is shown an enlarged view of the light guide 200 of FIG. 2. As can be seen from an interior 210 of the light guide 200, the lateral side walls 255 on the interior 210 of the light guide 200 include a reflective material 260. The reflective material 260 is connected to the interior walls 255 of the light guide 200 and returns light energy back into the interior space 210 of the light guide 200. One aspect of the present invention includes that the light emitting diodes 240 are arranged in four banks of light emitting diodes or a first bank of light emitting diodes, a second bank of light emitting diodes, a third bank of light emitting diodes, and a fourth bank of light emitting diodes all arranged next to one another along a top edge 245 located in a rear end 215 of the display screen 108. Although, four banks of light emitting diodes 240 are used, it is envisioned that the light guide 200 may be arranged with any number of banks of light emitting diodes.

In one aspect, each of the banks of light emitting diodes 240 is disposed in proximity to the first focal point 230. Light emitted by each bank 240 is reflected off the lateral side walls 255 having the reflective surface 260 and to the second focal point 235. In this aspect, the light that is directed/reflected to the second focal point 235 may be later directed to properly illuminate the rear end or proximal portion 215 of display screen 108. In one aspect, the entire light guide 200 alternatively may be arranged as an elliptical shaped member, or alternatively the housing 205 may have one or more elliptical shaped sections 220. Various configurations are possible and within the scope of the present disclosure. In one aspect, each of the banks of light emitting diodes 240 is disposed directly adjacent to, near, or in the first focal point 230 measured relative to the elliptically shaped surface 220.

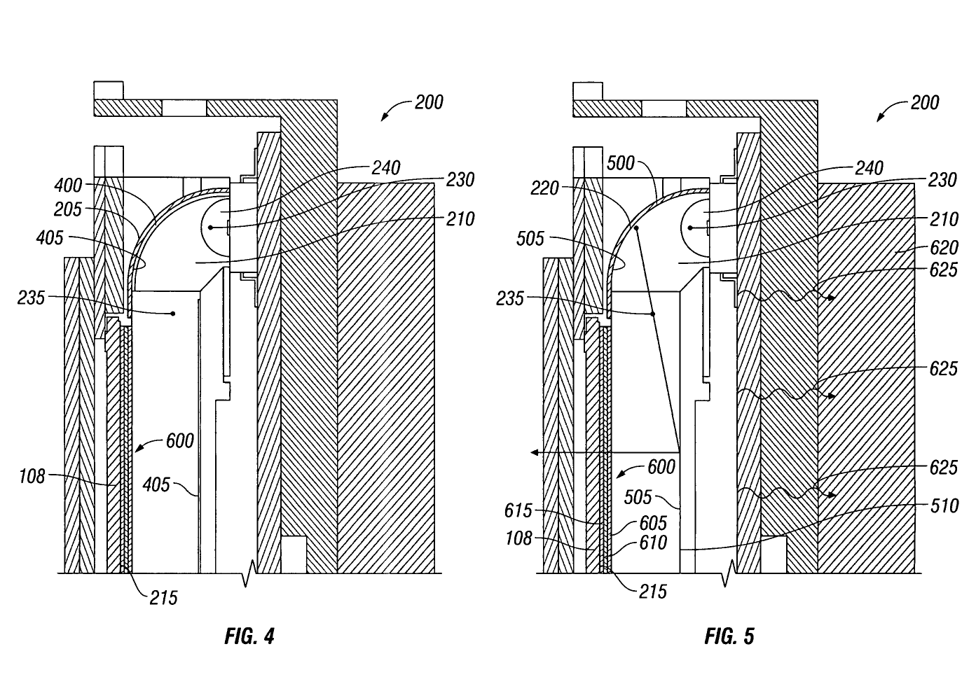

Turning now to FIG. 4, there is shown a cut away lateral side view of the light guide 200. As is shown, the banks of light emitting diodes 240 may be disposed adjacent to one another with each disposed directly adjacent or in the first focal point 230 so that the light emitted from the first focal point 230 is directed to the second focal point 235 (which is disposed in the interior space 210 of the light guide 200 to direct light to the rear end 215 of the display screen 108). FIG. 4 shows one embodiment of a lateral inner surface 400 of the light guide 200. In this embodiment, a lateral (inner wall) surface 400 of the light guide 200 comprises a discrete reflective surface 405 that is connected to the lateral surface 400. It should be appreciated that the light guide 200 may have any number of discrete reflectors 405 to ensure that the rays emitted from the bank 240 is directed from the first focal point 230 of the housing 205 or lateral surface 400 to the second focal point 235 disposed closer to the rear end 215 of the display 108. The discrete reflectors 405 may comprise chrome, a mirror, or a plated reflective material.

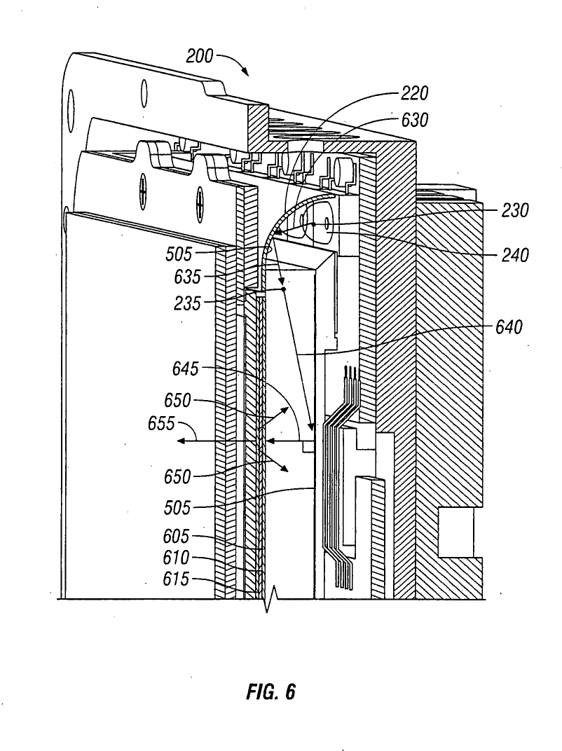

Turning now to FIG. 5, there is shown another alternative embodiment of the light guide 200. In this embodiment, the light guide 200 comprises the bank of light emitting diodes 240 that is disposed or positioned at the first focal point 230. However, in this embodiment, the light guide 200 comprises a deposited reflective surface 500 that is disposed along the entire inner surface 505 of the walls of the light guide 200. In this manner, separate discrete reflectors 405 (FIG. 4) are not needed and any light that is emitted from the banks of light emitting diodes 240 is directed to the second focal point 235 and into the interior 210 of the light guide 200 to ultimately illuminate the display screen 108 at the rear end 215. In one non-limiting preferred embodiment, the reflective surface 505 comprises a specular reflector made by 3M of St. Paul, Minn. In another embodiment, the surface 505 may comprise VIKUITI™ Enhanced Specular Reflector made by 3M, or alternatively may be any thin, mirror-like, non-metallic film that offers greater than 98% specular reflectivity across the entire visible spectrum and designed to increase the cavity efficiency of backlight sub-assemblies. In another embodiment, the reflective surface 505 disposed on the elliptical shaped surface 220 may be different than that of a lateral surface 510 positioned across the rear end 215. In one embodiment, the lateral surface 510 may be configured to include a specular reflector, while the elliptical shaped surface 220 may include a different reflective surface such as, for example, a mirrored surface. Various configurations are possible and within the scope of the present disclosure, and the description is not limited to any specific reflectors.

In each of the embodiments of FIGS. 1 through 5, the light guide 200 comprises a diffusing element 600 that is placed at the rear edge 215 of the display screen 108 (FIG. 5). In this embodiment, the diffusing element 600 preferably redirects the scattered light from interior 210 of the light guide 200. Originally, light is directed to the second focal point 235 (FIG. 5) and then contacts the specular reflector 505 on surface 510. The specular reflector 505 the redirects light at about ninety degrees to the rear end 215 which is then transmitted by diffuse transmission to the display screen 108 through a diffusing element 600. In one embodiment, and as shown, the diffusing element 600 comprises an optical film. The optical film 600 is preferably any optical film suitable for use as a diffuser. The optical film 600 receives the light directed to the second focal point 235 (FIG. 5) and directs the received light to the display screen 108 as shown in a diffuse manner. Preferably, in one embodiment, the light guide 200 uses three optical films, or a first optical film 605, a second optical film 610, and a third optical film 615.

In one exemplary embodiment, the first optical film 605 is a suitable diffusing optical film and preferably receives the highly concentrated light from an interior 215 of the light guide 200 and from the reflective surface 505. The first optical film 605 orients the light in a predetermined manner in a direction toward the rear end 215 of the display panel 108. The second optical film 610 is disposed closely adjacent to the first optical film 605. In one embodiment, the second optical film 610 is a suitable brightness enhanced film (BEF) and communicates the light to the third optical film 615. The second optical film 610 preferably controls an efficiency and is configured to brighten the light directed to the display panel 108 by transmitting the light in an effective manner. The third optical film 610 preferably returns poorly orientated light back into the interior 215 of the light guide 200, and for later reorienting or recycling the light so the light may be reflected from the reflective surface 505 and then reenter the first optical film 605 at the proper angle. The third optical film 615 preferably may be a dual reflective brightness enhancing film (DEBEF) manufactured by Minnesota Mining and Manufacturing Company, of St. Paul, Minn. The dual reflective brightness enhancing film 615 thus increases the efficiency of the visible light and finally communicates the properly orientated light to the display panel 108. It should be appreciated that the first through third optical films 605, 610, 605 are very sensitive to heat and may warp if the heat is not properly controlled. In this manner, the light guide 200 preferably includes a heat sink 620. The heat sink 620 is located adjacent the light guide 200 and preferably draws in the excess heat to prevent the optical films 605, 610, 615 from potentially being damaged by the heat as shown by arrows 625. In another aspect, the first through third optical films 605, 610, 615 preferably are disposed floating between the light guide 200 and the display panel 108 at rear end 215. In this manner, the first through third optical films 605, 610, and 615 may effectively control the heat without becoming damaged. This floating arrangement permits the films 605, 610, and 615 to stretch slightly and contract slightly by a predetermined amount without disturbing an orientation of the films 605, 610, 615 or excessively heating or cooling them such as when the display panel is turned on or off which may distort the shape of the films 605, 610, 615.

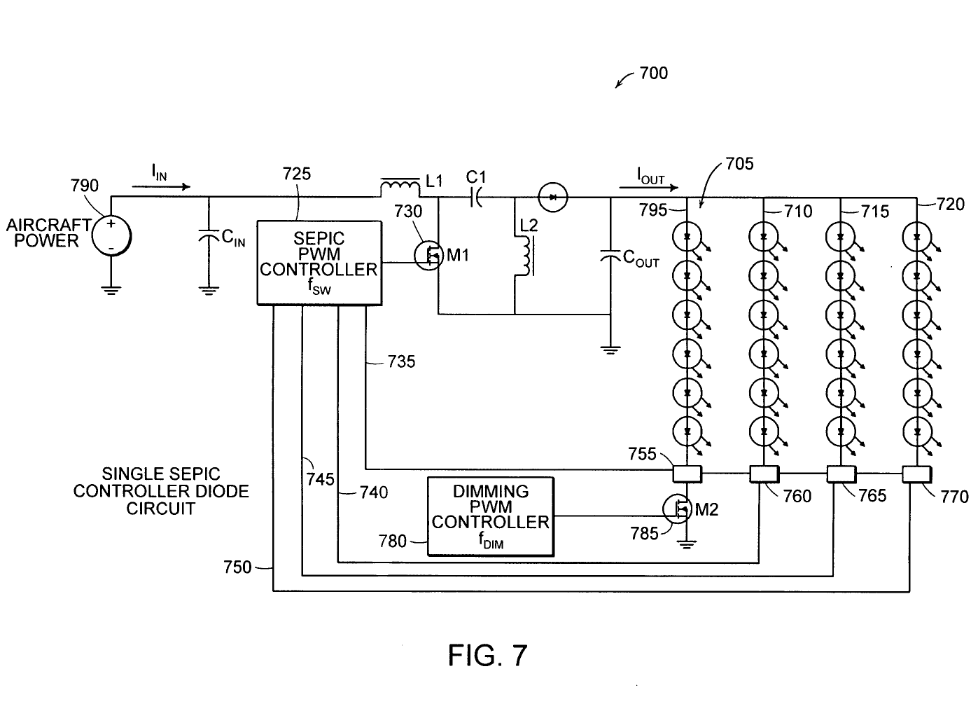

Referring now to FIG. 6, there is shown a ray path for light that is emitted from the banks of light emitting diodes 240. The light that is emitted by each bank of light emitting diodes 240 is directed from a direction at the first focal point 230 as shown by arrow 630. Thereafter, the light contacts the elliptical shaped wall surface 220 and reflective material 505. The light is then redirected to the second focal point 235 as shown by arrow 635. The light can further contact another reflective surface 505 as shown by arrow 640. Here, the reflective surface 505 includes a number of microstructures. In one embodiment, the microstructures are micro-prisms that direct the light of the light guide 200 as shown by arrow 645 at an angle of about ninety degrees relative to the lateral surface 510 and through the first optical film 605. The light is then directed through the first optical film 605 and into the second optical film 610 where the brightness of the light is enhanced. Thereafter, the enhanced light is communicated rear of the third optical film 615 where some of the inefficient light is returned to the interior 250 of the light guide 200 as shown by reference arrow 650. Thereafter, the enhanced light is communicated to the third optical film 615. In this manner, when the light traverses through the third optical film 615, the light is diffused through the third optical film 615 as shown by arrow 655 to provide the backlight for the display screen 108. It should be appreciated that various other diffusers may be used with the present disclosure and the display screen 108 may be configured to operate with more than three optical films 605, 610, and 615 than shown to achieve a desired brightness. Various configurations are possible and within the scope of the present disclosure.

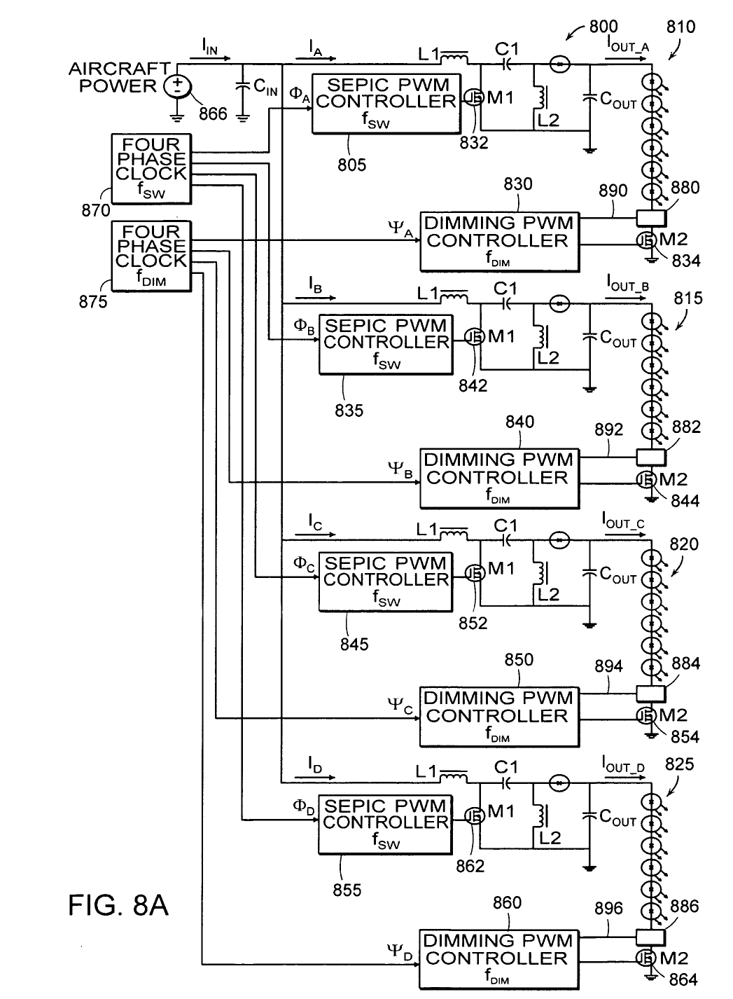

FIG. 7 shows a circuit diagram of an exemplarily control circuit 700 according to an embodiment of the present disclosure. In this embodiment, control circuit 700 preferably has a number of banks of light emitting diodes shown as four banks 705, 710, 715, and 720, although it should be appreciated that the present disclosure can be used with any number of banks of light emitting diodes such as five, six, seven or any number. In this embodiment, generally, the control circuit 700 preferably controls the illumination of the banks 705, 710, 715, and 720 so that each bank is illuminated sequentially and so no two banks are illuminated during the same time period or phase to control a current surge that is applied during each phase. More particularly, the control circuit 700 also develops a signal from each bank 705, 710, 715, and 720 to determine whether the respective bank is functioning or non-functioning. In this aspect, and based on this signal, the control circuit 700 maintains an overall level of illumination for the display 100 by terminating current to the non-functioning bank(s) 705, 710, 715, 720 and boosting current to the functioning bank(s) 705, 710, 715, 720.

In this embodiment, each bank 705, 710, 715, 720 has six individual light emitting diodes connected in series. The control circuit 700 includes a first bank of six light emitting diodes 705, a second bank of six light emitting diodes 710, a third bank of six light emitting diodes 715 and a fourth bank of six light emitting diodes 720. Each of the light emitting diodes of the first bank 705 is connected in series. Each of the light emitting diodes of the second bank 710 is also connected in series. Likewise, each of the respective light emitting diodes of the third and fourth banks is also connected to one another in the series.

The control circuit 700 further includes a controller 725. The controller 725 can be any digital signal processor known in the art such as one manufactured by Phillips Semiconductor®, Intel®, or Advanced Micro Devices®, Freescale Semiconductor®, Taiwan Semiconductor®, or another digital signal processor. In another embodiment, the controller 725 may be one or more discrete logic units. Preferably the controller 725 can control the illumination of each of the banks 705, 710, 715 and 720. The controller 725 controls the timing of illumination or the timing to terminate illumination. In this aspect the control circuit 700 employs a field effect transistor 730 that is connected to the controller 725. As can be seen, the control circuit 700 further includes inductance L1, L2 and a capacitance C1, and Cₒᵤₜ.

The diagram of control circuit 700 is shown as a simplified diagram. In this aspect the controller 725 is connected to leads 735, 740, 745 and 750. Lead 735 connects the controller 725 to an element 755, which is coupled to first bank 705. Lead 740 connects controller 725 to element 760, which is coupled to second bank 710. Lead 745 connects the controller 725 to element 765, which is coupled to third bank 715. Lead 750 connects the controller 725 to element 770, which is likewise coupled to fourth bank 720.

Elements 755, 760, 765 and 770 are preferably resistive elements. In this aspect the controller 725 can develop an error signal across each of the banks of light emitting diodes 705, 710, 715 and 720. This error signal is particularly useful, as controller 725 can determine an intensity of the light emitting diodes 705, 710, 715 and 720 from the error signal, and further determine whether each bank 705, 710, 715, 720 is illuminated or non-illuminated.

The control circuit 700 also performs other functions. In one aspect, the subject controller 725 can sequentially illuminate the first bank of light emitting diodes 705 in phase with other banks. The controller 725 can terminate the illumination of the first bank of light emitting diodes 705 and then illuminate the second bank of light emitting diodes 710. Advantageously, this is done sequentially immediately after termination of the illumination of the first bank of light emitting diodes 705. After the illumination of the second bank of light emitting diodes 710, the controller 725 can switch off the second bank of light emitting diodes 710 and then immediately switch on the third bank of light emitting diodes 715. Thereafter, the subject controller 725 can control the third bank of light emitting diodes 715 and switch off the third bank of light emitting diodes 715 and then immediately switch on the fourth bank of light emitting diodes 720. In this aspect, the controller 725 can sequentially time the illumination of the first through the fourth banks of light emitting diodes 705, 710, 715 and 720 so that the first through fourth banks of light emitting diodes 705, 710, 715, 720 are synchronized and no two banks of light emitting diodes 705, 710, 715, 720 are illuminated during the same time period or phase. This is advantageous since the controller 725 can control a maximum current surge by illuminating only one of the banks 705, 710, 715, 720 per phase so a peak current is below a maximum current (threshold) relative to an instance if all the banks were illuminated at the same time or during the same phase. Notably, this switching is conducted at a very high frequency, such as over 60 Hertz. The frequency is suitable such that to the normal human eye it appears that all of the banks of light emitting diodes 705, 710, 715, 720 are on continuously (i.e., no blink, blinking, or lack of illumination is visually detected by the human eye).

The control circuit 700 further includes a second controller 780. The second controller 780 is connected to a second field gate transistor 785. It should be appreciated to one of ordinary skill in the art that the control circuit 700 can be manufactured with only one controller 725 for the purposes of the present disclosure, or two controllers 725, 780 performing separate discrete functions. It is also envisioned that the tasks of controller 725 may be conducted by controller 780 and vice versa.

In essence, referring to the control diagram 700 the controller 725 will develop an error signal along the leads 735, 740, 745 and 750. The controller 725 determines an intensity of one or all of the banks of light emitting diode banks 705, 710, 715, and 720. The first controller 725 may receive the signal from the second controller 780, or alternatively the second controller 780 references the determined intensity with a threshold intensity stored in a memory (not shown). In this aspect, the first controller 725 can determine whether one, two, three, or all four banks of light emitting diodes 705, 710, 715, and 720 are functioning.

In turn, the first controller 725 controls responsively second controller 780 to boost power received from the aircraft power input current 790 that is transmitted to the predetermined bank(s) of the light emitting diodes 705, 710, 715, and 720. For example, the first controller 725 can determine whether an entire bank of light emitting diodes such as the first bank of light emitting diodes 705 is non-functioning. If the first bank of light emitting diodes 705 is non-functioning, current will travel through line 795 through the bank 705 to element 755 and then to the first controller 725 along lead 735.

In this aspect and from this signal, first controller 725 determines whether the first bank of light emitting diodes 705 is illuminated, non-illuminated or not functioning. If first bank of light emitting diodes 705 is not functioning, the first controller 725 controls the second controller 780 to boost the intensity of the remaining banks of light emitting diodes 710, 715, and 720. In one aspect, the control circuit 700 may have a set brightness value of, for example, 1000 Nits of brightness or luminance. If one bank of light emitting diodes is rendered nonfunctioning and the brightness is immediately reduced, for example, by 25% to 750 Nits of brightness then the first controller 725 controls second controller 780 to boost the power to the three remaining functioning banks of light emitting diodes 710, 715, and 720 to reachieve the desired brightness of, for example, 1000 Nits of brightness. It is also envisioned that the tasks of first controller 725 may be conducted by controller 780 and vice versa. Various configurations are possible and within the scope of the present disclosure.

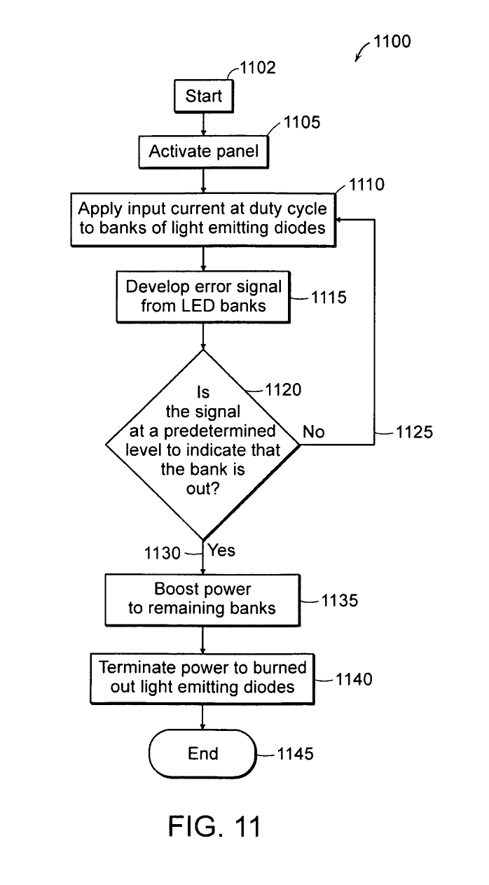

Turning now to an exemplary method of the present disclosure shown in FIG. 11, there is shown a method of the present disclosure that the first controller 725 uses in order to evaluate whether one, two, three, or all four banks of light emitting diodes 705, 710, 715, 720 are functioning or non-functioning. Turning now to FIG. 11, there is shown a number of steps that a digital signal processor can access from a memory as program instructions to operate the control circuit 700 of FIG. 7.

The method 1100 is shown starting at a block 1102. Thereafter, control of the method 1100 passes to block 1105 where a display panel as shown in FIG. 1 is activated. Thereafter, the method 1100 further has the step 1110. At step 1110, the input current is applied at a duty cycle to each bank of light emitting diodes as is discussed in the present disclosure. Thereafter, the first controller 725 of FIG. 7 develops an error signal from each of the light emitting diode banks (step 1115). As shown, in FIG. 7 in one embodiment, the control circuit 700 has elements 755, 760, 765 and 770 which might be a resistor to develop an error signal to determine whether the respective first, second, third or fourth banks are illuminated and functioning. The control of the method 1100 then passes to a decision block 1120 once the error signal is developed from the light emitting diode banks at step 1115.

At the decision block 1120, the method 1100 makes a determination. Once the method 1100 receives the developed error signal, the determination is whether the signal is at a predetermined level to indicate that the respective bank is out or non-functioning. In one embodiment, the controller 725 accesses a table stored in the memory to compare the error signal to a threshold to determine whether the respective first, second, third, and fourth light emitting diode banks 705, 710, 715, and 720 are non-illuminated or non-functioning. However, other various configuration are possible and within the scope of the present disclosure, such as using a formula, or model. If the method 1100 determines that the signal is not at the predetermined level to indicate that the bank is out or non-functioning, control passes along line 1125 to step 1110 where an input current and a duty cycle is applied to the banks of the light emitting diodes.

At decision block 1120, if the signal is at a predetermined level that does indicate that one or more banks are non-functioning, control passes along line 1130 to step 1135. At step 1135, the method 1100 boosts power to the remaining banks of light emitting diodes. Boosting means any amplification, supplying more current or undertaking any action for which to safely increase illumination. In one embodiment, the four banks of light emitting diodes 705, 710, 715, and 720 of FIG. 7 together may achieve a certain predetermined brightness level (i.e., total brightness). For example, this brightness could be in the order of 1,000 to 800 Nits of brightness. In another embodiment, the level could be lower such as 500 Nits of brightness. However, if one or more banks of light emitting diodes 705, 710, 715, 720 are non-illuminated, the present method 1100 has the function that the method increases illumination of the remaining light emitting diodes to re-achieve the desired level of brightness. The remaining light emitting diodes increase intensity and overall brightness for the panel to remain at substantially the same total brightness level, and one observing the screen 108 of FIG. 1 would not be able to noticeably determine that one or more banks are out (i.e., not illuminated).

Turning back to FIG. 11, once the determination is made and power is boosted to remaining banks at step 1135, control of the method 1100 passes to step 1140. Here, the method 1100 terminates power to the burned out or otherwise non-functioning bank(s) of light emitting diodes. Thereafter, control of the method 1100 passes to step 1145 where the method 1100 is ended. In another alternative embodiment of the present disclosure, it should be appreciated that the set of four light emitting diode banks is not limiting and there could be any number of banks of light emitting diodes and the present disclosure is not intended to be limited to any discrete number of light emitting diode banks as shown is FIG. 7.

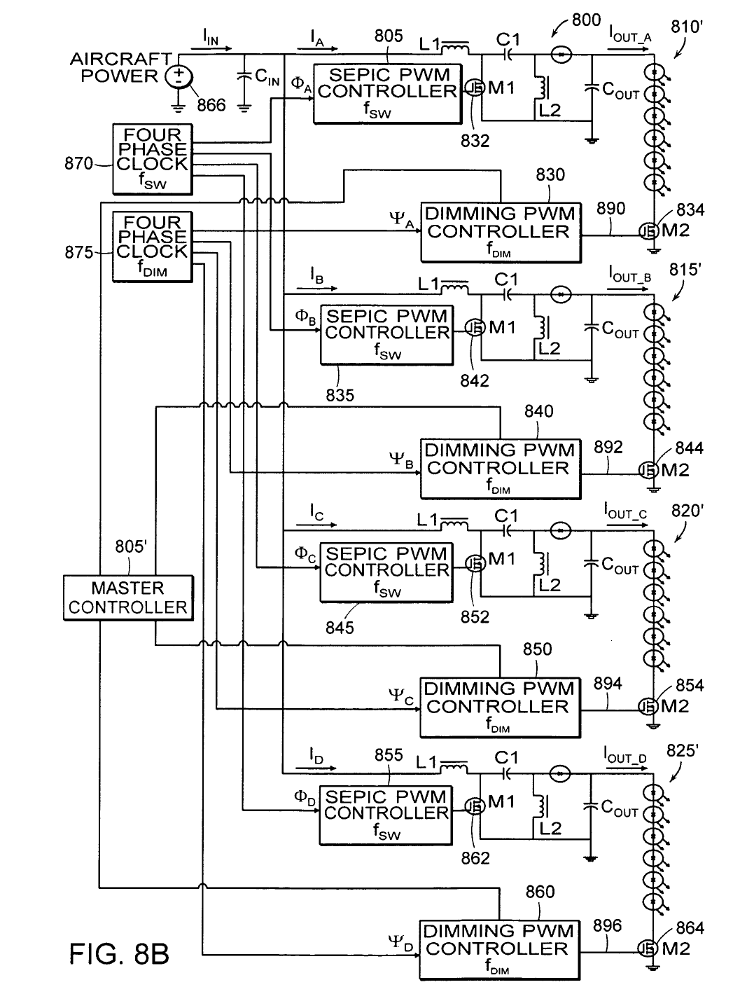

Turning now to FIG. 8A there is shown another control circuit 800 according to another embodiment of the present invention. In this embodiment, control circuit 800 is shown having a first bank of light emitting diodes 810, a second bank of light emitting diodes 815, a third bank of light emitting diodes 820, and a fourth bank of light emitting diodes 825. In this embodiment, each bank of light emitting diodes includes six light emitting diodes. However, it should be appreciated that any numbers of light emitting diodes per banks such as seven, eight, nine or ten light emitting diodes may be used in other embodiments and depending on the display. Notably, control circuit 800 includes a first phase of light emitting diodes 810, a second phase of light emitting diodes 815, a third phase of light emitting diodes 820 and a fourth phase of light emitting diodes 825. In this aspect, the control circuit 800 includes first controllers 805, 835, 845, 855 that have an input that receives a clock signal from the four phase clock 870.

The control circuit 800 also has second controllers 830, 840, 850, and 860 that receive a clock signal from the second four phase clock 875. In this manner, the first controllers 805, 835, 845, 855 can compare the timing signals from the four phase clock 870 to sequentially illuminate the light emitting diodes so each bank is illuminated sequentially out of phase with other banks and no two banks are illuminated during the same phase. The second controllers 830, 840, 850, and 860 can receive the timing signals from the second clock 875. The control circuit 800 illuminates the first phase, terminates the illumination of the first phase 810, then illuminates the second phase 815, terminates the illumination of the second phase of light emitting diodes 815, then illuminates the third phase 820 of light emitting diodes, then terminates illumination of the third phase of light emitting diodes, then illuminates the fourth phase of light emitting diodes 825, then terminates illumination of the fourth phase of light emitting diodes 825, then continues to illuminate the first phase again and sequentially cycle through the phases in this manner using the timing signals of clock 870.

The control circuit 800 is connected to the aircraft power as shown by reference number 866 and an input current is be supplied for each of the four phases. The control circuit 800 has two four phase clocks 870 and 875. The four phase clocks have leads that communicate to each individual controller or controller 805, controller 835, controller 845 and controller 855 for each phase.

Referring now to the first phase, the controller 805 includes a field gate transistor 832. The field gate transistor 832 can terminate illumination to the first bank of light emitting diodes 810. Likewise, the second phase includes controller 835 and a field transistor 842. The field gate transistor 842 can illuminate or terminate illumination of the second bank of light emitting diodes 815. Likewise, the third phase includes a field gate transistor 852 that is inserted between the controller 845 and the third bank of light emitting diodes 820. The field gate transistor 852 can turn on or off the third bank of light emitting diodes 820. Similarly, the fourth phase includes controller 855 and field gate transistor 862. The field gate transistor 862 can terminate illumination or illuminate the fourth bank of light emitting diodes 825. Accordingly, operation of the circuit 800 will next be discussed with regard to the second controllers 830, 840, 850, and 860.

Turning to FIG. 8A, each phase includes second controllers 830, 840, 850, and 860 or dimming power controllers. Referring to the first phase, the second controller is shown as reference numeral 830 and the second phase dimming power controller is shown as reference numeral 840. The third and fourth phase second controllers are shown as reference numerals 850 and 860 respectively. In this particular embodiment of FIG. 8A the control circuit 800 includes a first element 880, a second element 882, a third element 884 and a fourth element 886. Element 880 in one embodiment is a resistor. The element 880 is connected to the second controller 830 along lead 890. In the second phase, element 882 is connected to second controller 840 along lead 892. In the third phase, element 884 is connected to second controller 850 along lead 894. In the fourth phase, element 886 is connected to second controller 860 along lead 896. The control circuit 800 further comprises second field gate transistors 834, 844, 854, 864 in each of the phases.

In this aspect, an error signal is developed from the elements 880, 882, 884, and 886 to determine whether the respective first bank of light emitting diodes 810, second bank of light emitting diodes 815, third bank of light emitting diodes 820 and/or the fourth bank of light emitting diodes 825 are illuminated or non-illuminated. The second power controllers 830, 840, 850 and 860 receives the error signal along the respective leads 890, 892, 894 and 896; and then using the field gate transistors 834, 844, 854 and 864, the respective second controllers 830, 840, 850, 860 boost illumination to remaining banks of light emitting diodes that are still functioning and/or terminate illumination to the bank of light emitting diodes that are non-functioning. It should be appreciated in FIG. 8A that the first element 880, the second element 882, the third element 884 and the fourth element 886 are preferably resistors, or other resistive elements. However, it should be appreciated that the first through fourth elements 880, 882, 884, and 886 could be other elements such as an inductance, a capacitance, or any other element where the respective second controllers 830, 840, 850, and 860 can develop an error signal from current traversing through the respective element. Turning now to FIG. 8B there is shown a second control circuit 800′.

In the second control circuit 800′ which is similar to the embodiment shown in FIG. 8A, the control circuit 800′ does not include the first through fourth elements 880, 882, 884, and 886 as shown in FIG. 8A. Instead, in this embodiment, the second controller 830 is connected by lead 890 to the field gate transistor 834. Here, the error signal may be alternatively developed by the connection between the respective controller 830, 840, 850 and 860 and the bank of light emitting diodes shown 810′, 815′, 820′ and 825′. In the embodiment of FIG. 8B, the control circuit 800′ also includes a master controller 805′ (which may be in one embodiment a controller associated with an avionics instrument panel).

Master controller 805′ is connected to each of the second controllers 830, 840, 850, and 860. Master controller 805′ in this embodiment coordinates operations of each of the second dimming controllers 830, 840, 850, and 860 such that the master controller 805′ can control second controllers 830, 840, 850, and 860 to terminate illumination or increase the brightness of the light emitting diode banks 810′, 815′, 820′, and 825′.

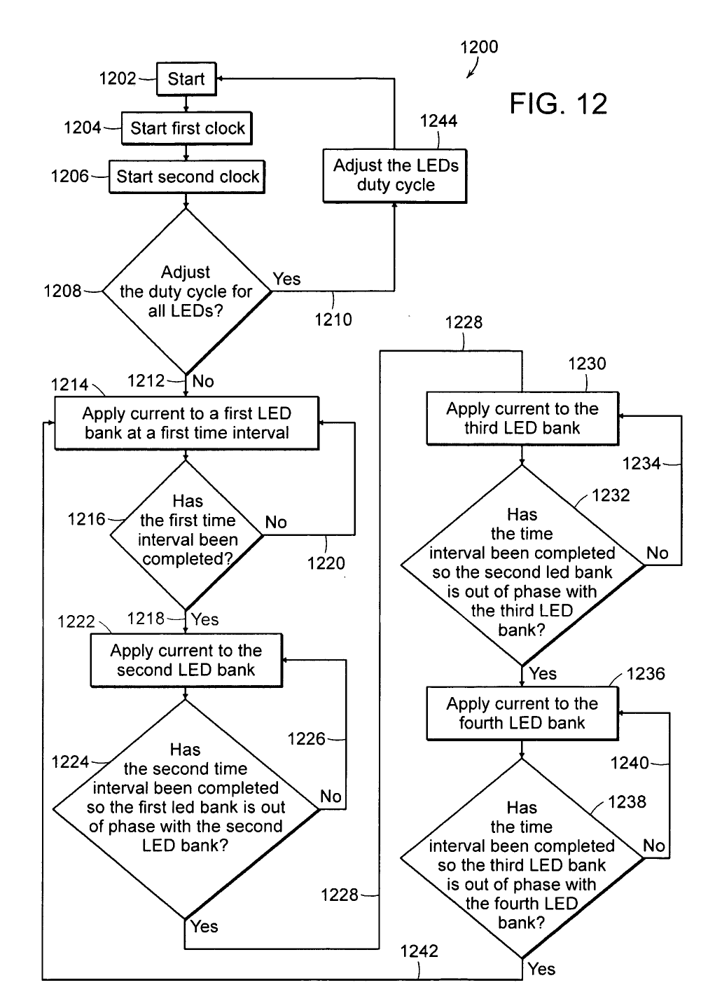

Turning now to FIG. 12, there is shown an example method of the present invention as indicated with reference numeral 1200. Simply by way of background, the method 1200 of the present disclosure shown in FIG. 12 operates using the control circuits shown in FIGS. 8A and 8B. The method 1200 can operate using the controllers in FIGS. 8A and 8B shown at reference numerals 805, 835, 845 and 855.

Preferably, the method 1200 allows for operation of multiple illumination phases for three or more banks of light emitting diodes. As discussed, a four phase clock or four identical clock signals shown in FIGS. 8A and 8B are shifted equally in time from each other by the clock divided by the number of phases. The control circuit 800 preferably draws current for illumination purposes at different moments in time to reduce current surges associated with the control circuit. The method 1200 starts at step 1202. Then control is passed to step 1204 where the first clock is started. Control passes then to step 1206 where a second clock is started. Thereafter the method 1200 further includes a decision block 1208. At decision block 1208, the controller or other logic circuits determine whether the duty cycle for all light emitting diode banks needs to be adjusted. Various duty cycles and intensity for each of the banks of the light emitting diodes shown in FIGS. 8A and 8B are envisioned and generally depending on the desired intensity or brightness level of the panel, the preliminary adjustment may be needed such as shown in decision block 1208.

The method 1200 determines if the duty second needs to be adjusted then, if an adjustment is needed, the method 1200 will pass along line 1210 to step 1244 to adjust the duty cycle of one or each of the banks of light emitting diodes. Then, the method 1200 returns back to step 1202.

At decision block 1208, if the method 1200 determines that the duty cycle for one or all the LEDS does not need to be adjusted, then control passes along the line 1212 to step 1214. At step 1214, the method 1200 further includes the step of applying a current to a first light emitting diode bank at a first time interval. As discussed previously the method 1200 sequentially illuminates one bank of light emitting diodes, terminates illumination of that bank and then illuminates a second bank so the two banks are out of phase with one another. Referring again to step 1214, a current is applied to a first light emitting diode bank for a first time interval, or phase. Thereafter the method 1200 receives signals from the respective clock and determines whether the time interval has been completed (i.e., for applying current to the first light emitting diode bank at the first time interval) at step 1216. If the time interval has not been completed, control for the method 1200 passes along line 1220 back to step 1214 to continue to provide current to the first light emitting diode bank.

At decision step 1216, if the first time interval has been completed, then control passes along line 1218 to step 1222. At this point, once the first time interval for the first bank of light emitting diodes has been completed, the method 1200 turns the first bank of light emitting diodes off, or otherwise terminates illumination thereof. Thereafter, at step 1222, a current is applied to the second bank of light emitting diodes. Thereafter, the method 1200 continues and control passes to decision step 1224.

At decision step 1224, and as shown in FIGS. 8A and 8B, the method 1200 continues to receive timing signals from the respective clock. At this step 1224, the controller is already applying current to the second bank of light emitting diodes and then determines at decision block 1224 whether the first time interval has been completed for the second bank of light emitting diodes so that the first bank of light emitting diodes is not illuminated and is out of phase with the second light emitting diode bank. If the method 1200 determines that this is not the case, then control passes along line 1226 to continue to apply current to the second light emitting diode bank at step 1222.

At decision block 1224, if the second time interval is completed for the second bank of light emitting diodes, then control passes along step 1228 to step 1230. At step 1230, the method 1200 applies current to the third light emitting diode bank and the current to the second bank of light emitting diodes is terminated. Thereafter, control passes to decision block 1232. At decision block 1232, the method 1200 determines whether the time interval has been completed so that the second light emitting diode bank is out of phase with the third light emitting diode bank or that the second light emitting diode bank is non-illuminated while the third bank of light emitting diodes is illuminated. If the time period is completed so the second light emitting diode bank is out of phase with the third light emitting diode bank then control of the method 1200 passes to step 1236. If the time period has not been completed the method 1200 proceeds along line 1234 back to step 1230 to continue to apply current to the third light emitting diode bank while the second light emitting diode bank is non-illuminated.

At step 1236, the current is applied to the fourth light emitting diode bank. Thereafter, the method 1200 continues to decision block 1238. At decision block 1238 the method 1200 reaches a determination as to whether the time interval has been completed so the third light emitting bank is now out of phase with the fourth light emitting diode bank. If a negative decision is reached at decision block 1238, the method 1200 proceeds along line 1240 back to step 1236 to continue to apply current to the fourth light emitting diode bank while the third bank of light emitting diodes is non-illuminated. At decision block 1238, if the time interval has been in fact completed so that the third light emitting diode bank is out of phase with the fourth light emitting diode bank, then the method 1200 terminates illumination of the fourth bank of light emitting diodes and control passes along line 1242 to then return to step 1214 to apply current to the first light emitting diode bank at the first time interval. Thereafter, the method 1200 has program instructions and continues so long as the display panel shown in FIG. 1 is illuminated. The illustrated cycle of illumination of LED banks provides energy savings measured without loss of the level of brightness (luminescence). It should be appreciated that the present method 1200 may be used with other illumination devices and is not limited to light emitting diodes. It should also be appreciated that the present disclosure is intended to encompass slight overlaps between the illumination of one bank and another bank, and is not limited to only completely out of phase operation between banks of light emitting diodes.

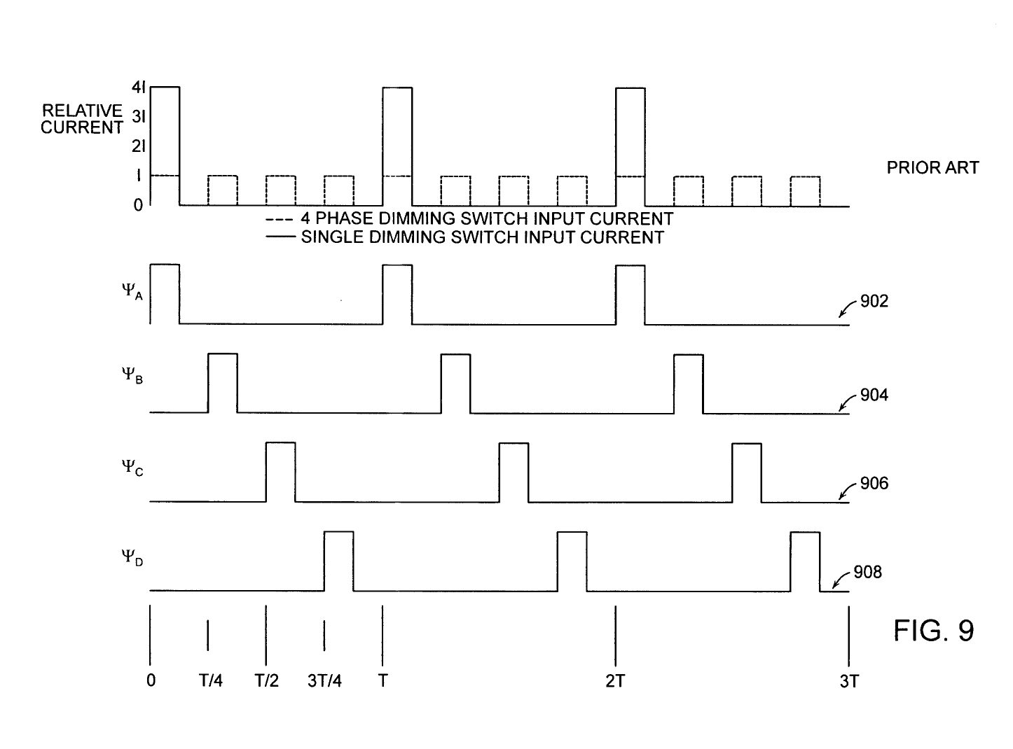

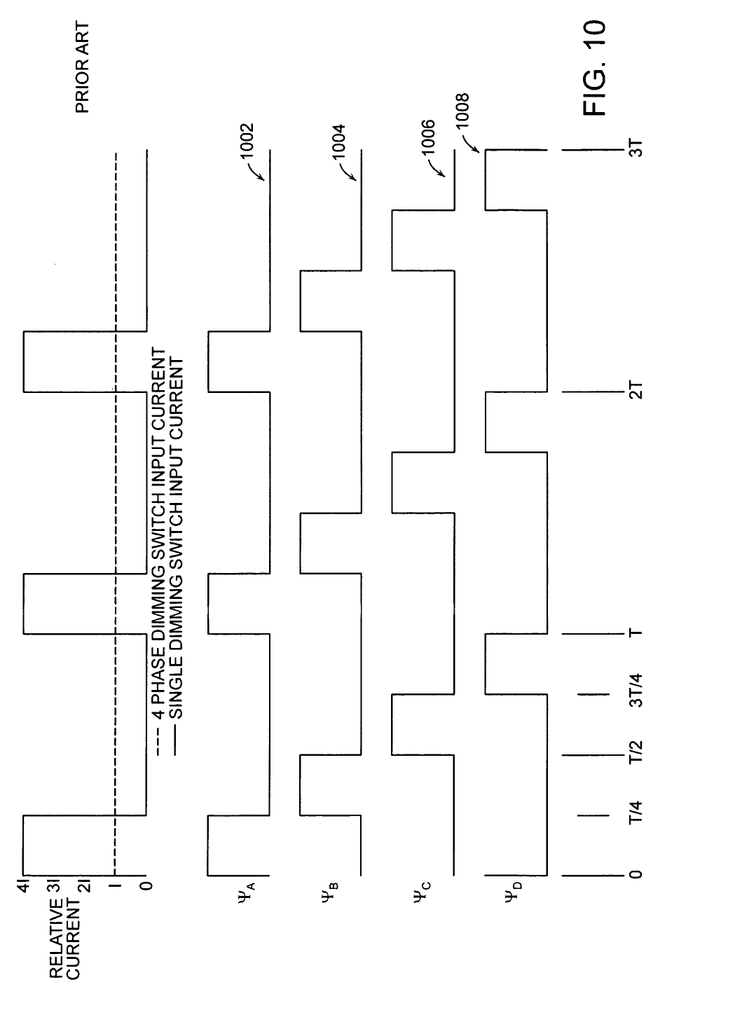

Turning now to FIG. 9 and FIG. 10 it is appreciated that the method 1200 controls a plurality of light emitting diodes in a number of banks and reduces current surges. The method times the illumination of separate banks so that separate banks are synchronized and neither bank of light emitting diodes is illuminated during the same phase of operation. As shown in FIG. 9, there is a first graph of the relevant current on the y-axis versus time period shown in the x-axis. As can be appreciated by the first graph labeled prior art on FIG. 9 there is shown a current over time graph of a present light emitting diode panel where all the banks of light emitting diodes are illuminated at the same time period or during the same phase. As can be seen by the graph labeled prior art, FIG. 9, by having the light emitting diodes not synchronized and all being illuminating during the same stage or phase, a peak current surge is felt as indicated at 4I.

It should be appreciated that this peak current surge labeled by 4I has a number of undesirable effects. The first undesirable effect is at the peak current surge of 4I there is a relatively large peak current which results in a relatively large magnetic field generated by the peak current. The second undesirable effect of the prior art system is that in order to transition from one peak to the next peak by illuminating all four banks of light emitting diodes at the same time or phase, the components will undergo a high current surge to transition from one peak current to the next. This high current surge requires a large amount of capacitance and costly components associated with operation of the light emitting diodes. Alternatively, by operating the prior art system where all of the banks of the light emitting diodes are illuminated at the same phase (or during the same time interval), more expensive input capacitors need to be used and more shielding needs to be installed for the prior art system to operate. This can increase the costs associated with the prior art system.

Continuing with FIG. 9, there is shown the relative current over time for the first phase bank of light emitting diodes 902, the second phase bank of light emitting diodes 904, the third phase bank of light emitting diodes 906, and the fourth bank of light emitting diodes 908. As can be seen in FIG. 9 during the time interval “zero,” the current is supplied only to the first bank of light emitting diodes 902. At time T/4 current is supplied only to the second bank of light emitting diodes 904. At time T/2 current is supplied only to the third bank of light emitting diodes 906. At time 3T/4 current is supplied solely for the fourth bank of light emitting diodes 908 until time period T is reached.

At time period T, current is then applied again solely to the first phase of light emitting diodes 902 and then solely to the second phase 904, then to the third phase 906 and then to the fourth phase 908. As can be understood from FIG. 9, the controller in order to control illumination of the banks of light emitting diodes 902, 904, 906, 908 times the illumination so that the first, second, third and fourth bank of light emitting diodes 902, 904, 906, 908 are synchronized and so none of the banks are illuminated during the same phase to reduce the relevant current surges and to reduce the total current that is supplied during each phase. This also has the additional attribute of reducing the associated magnetic fields generated with such current surges and also reduces component costs.

It also should be appreciated that the magnetic field formed by the current through the banks of light emitting diodes 902, 904, 906, 908 and during each phase will also cancel each other out resulting in a net zero generated magnetic field. This reduction of the magnetic field further reduces shielding requirements for the display 100 as shown in FIG. 1. It should be appreciated that the normal human eye integrates the light over 60 Hertz. Preferably, the phases 902, 904, 906, 908 shown in FIG. 9, occur at a suitable frequency so all light emitting diodes appear to be illuminated or on at the same time to the human eye without detecting that they are run out of phase (cycled in a sequence).

Turning now to FIG. 10 there is shown another series of graphs of the relative current over time. In this embodiment, the four graphs are of the first phase 1002, the second phase 1004, the third phase 1006 and the fourth phase 1008 of the relative current over time. As shown in FIG. 10, the first phase 1002 is illuminated which results in an increase in the relative current at the first bank of light emitting diodes. At T/4, the first bank of light emitting diodes is turned off and the second phase of light emitting diodes 1004 is turned on immediately. As can be seen in comparison to FIG. 9 there is a slight lag between the first phase 902 and the second phase 904 where neither is illuminated. Turning to FIG. 10, as can be seen between the first phase 1002 and the second phase 1004, as soon as the first phase 1002 is switched off the second phase 1004 is immediately switched on for a relatively increased time period relative to the embodiment of FIG. 9. The second phase 1004 is switched on from T/4 to T/2. Then, the second phase 1004 is switched off. The third phase of light emitting diodes 1006 is then switched on from T/2 to 3T/4. Finally, the fourth phase 1008 is switched on from 3T/4 to time period T. Thereafter, the cycle continues for the duration that the display of FIG. 1 is lit. It should be appreciated that any number of light emitting diodes can be used with the present invention. In one aspect, to achieve minimum redundancy such that the failure one phase will not diminish the overall capability of the system, the total number of diodes required can be calculated as a function of the minimum number of light emitting diodes as follows:

Total number of light emitting diodes=minimum number of light emitting diodes multiplied by (1+1/the number of phases).

It should be appreciated that the total is rounded up to the nearest whole number to calculate the total number of light emitting diodes.

While this invention has been particularly shown and described with references to preferred embodiments thereof, it will be understood by those skilled in the art that various changes in form and details may be made therein without departing from the scope of the invention encompassed by the appended claims.

What is claimed is:

1. A display panel comprising:
a light guide including a housing with at least one elliptical shaped surface including a first focal point and a second focal point disposed along a major longitudinal axis;
at least one light emitting diode being positioned in proximity to the first focal point;
a reflector associated with an inner surface of the housing; and
an optical film being positioned in proximity to an outlet of the housing, the outlet communicating with the display panel, wherein light emitted from the at least one light emitting diode passes through the first focal point and is reflected by the reflector to the second focal point and directed through the optical film and diffused to the display panel.

2. The display panel of claim 1, further comprising a plurality of light emitting diodes.

3. The display panel of claim 2, wherein the plurality of light emitting diodes is disposed in a bank, and wherein the bank is in proximity to the first focal point.

4. The display panel of claim 1, wherein the at least one light emitting diode is at the first focal point.

5. The display panel of claim 1, wherein the reflector is directly connected to the inner surface.

6. The display panel of claim 1, wherein the reflector is deposited on the inner surface.

7. The display panel of claim 1, wherein the optical film is a diffuser.

8. The display panel of claim 1, wherein the second focal point directs light to an interior of the light guide, wherein the light is collimated and directed to the outlet.

9. The display panel of claim 1, wherein the reflector is a specular reflector and is disposed on the inner surface.

10. The display panel of claim 1, wherein the at least one light emitting diode emits white light.

11. The display panel of claim 1, wherein the reflector is plated to the inner surface.

12. The display panel of claim 1, wherein light originating from the first focal point is directed to the second focal point and contacts at least one lateral surface of the light guide, the light reflecting off the lateral surface to enter the diffuser at about ninety degrees.

13. The display panel of claim 1, wherein the light guide is configured as a backlight for a liquid crystal display.

14. The display panel of claim 1, wherein the housing comprises a reflective inner surface.

15. The display panel of claim 1, wherein the reflector comprises a chrome surface.

16. The display panel of claim 1, further comprising at least two optical films associated with the diffuser, wherein at least one optical film enhances a brightness of the light, and wherein at least a second optical film returns improperly oriented light to an interior of the light guide.

17. A light guide comprising:
a housing including an elliptically shaped inner surface with a first focal point and a second focal point disposed along a major longitudinal axis;
the housing including a reflective surface associated with the elliptically shaped inner surface of the housing; and
a diffuser being positioned in proximity to an outlet of the housing, the light either reflected or originating near the first focal point is directed to the second focal point and directed to the outlet.

18. The light guide of claim 17, further comprising a light emitting diode disposed near the first focal point.

19. The light guide of claim 18, further comprising a plurality of light emitting diodes disposed in a series of banks, and wherein the series of banks are disposed at, or near the first focal point.

20. The light guide of claim 17, wherein the reflective surface comprises a reflector directly connected to the inner surface.

21. The light guide of claim 17, wherein the reflective surface is deposited on the inner surface.

22. The light guide of claim 17, wherein the diffuser is an optical film that is connected to the outlet.

23. The light guide of claim 17, wherein the second focal point directs the light to a second reflective surface, the second reflective surface configured to orient the light at about ninety degrees relative to the outlet.

24. The light guide of claim 17, wherein the reflective surface is a specular reflector.

25. The light guide of claim 18, wherein the light emitting diode emits white light.

26. The light guide of claim 17, wherein the reflective surface is plated to the inner surface.

27. The light guide of claim 17, further comprising at least two optical films associated with the diffuser, wherein the optical film and the at least two optical films are disposed at the outlet.

28. The light guide of claim 17, further comprising a liquid crystal display located at the outlet.

29. The light guide of claim 17, wherein the reflective inner surface comprises chrome.

30. The light guide of claim 17, further comprising at least two or more banks of light emitting diodes being under the first focal point.

31. A method of controlling a plurality of light emitting diodes configured for reducing current surges, the method comprising:
illuminating a first bank of light emitting diodes for a first time period, and at the conclusion of the first time period terminating illumination of the first bank of light emitting diodes;
illuminating a second bank of light emitting diodes for a second time period, and at the conclusion of the second time period terminating illumination of the second bank of light emitting diodes;
illuminating a third bank of light emitting diodes for a third time period, and at the conclusion of the third time period terminating illumination of the third bank of light emitting diodes;
illuminating a fourth bank of light emitting diodes for a fourth time period, and at the conclusion of fourth time period terminating illumination of the fourth bank of light emitting diodes;
repeating illumination of the first through fourth banks; and
synchronizing the illumination of first through fourth banks so no two banks of light emitting diodes are illuminated during the same time period.

32. The method of claim 31, further comprising switching consecutively the first through fourth banks from illuminated to non-illuminated at a frequency higher than a human eye can detect, the switching being suitable so that the first through fourth banks appear to be constantly illuminated.

33. The method of claim 31, further comprising controlling a maximum current surge by illuminating the first through fourth banks in phases so a peak current of each phase is below a maximum current surge, the maximum current surge being an instance when the first through fourth banks are all illuminated in phases during the same time interval.

34. The method of claim 31, further comprising illuminating white light.

35. A method of controlling a plurality of light emitting diodes configured for reducing current surges, the method comprising:
illuminating a first bank of light emitting diodes in a first phase, and at the conclusion of the first phase terminating illumination of the first bank of light emitting diodes;
illuminating a second bank of light emitting diodes for a second phase at the conclusion of the first phase, and
timing the illumination of the first and second banks so the first and second banks are synchronized and so neither bank of light emitting diodes is illuminated during the same phase.

36. The method of claim 35, further comprising switching consecutively the first through second banks from illuminated to non-illuminated at a frequency higher than a human eye can detect, the switching being suitable so that the first through second banks appear to be constantly illuminated.

37. The method of claim 35, further comprising controlling a maximum current surge by illuminating the first through second banks in phases so a peak current of each phase is below a maximum current surge, the maximum current surge being an instance when the first through second banks are all illuminated during at least a portion of the same time interval.

38. The method of claim 35, further comprising illuminating white light from the first and the second banks.

39. An apparatus for controlling a plurality of light emitting diodes, the apparatus comprising:
a logic unit for controlling illumination of a first bank of light emitting diodes for a predetermined duration;
a switch coupled to the logic unit and configured to terminate illumination of the first bank of light emitting diodes at the conclusion of the predetermined duration;
the logic unit configured to control illumination of a second bank of light emitting diodes by controlling the switch, the switch configured for switching on the second bank for a second duration at the conclusion of the first predetermined duration, and
wherein the logic unit times the illumination of the first and second banks so the first and second banks are synchronized and so neither bank of light emitting diodes is illuminated during the same moment in time.

40. The apparatus of claim 39, wherein the logic unit is a controller.

41. The apparatus of claim 40, wherein the switch comprises a field effect transistor configured to receive a signal from the controller, and configured to illuminate and terminate illumination of the first and second banks of light emitting diodes.

42. A method of controlling a display illumination, the method comprising:
illuminating a first illumination device for a first predetermined duration, and at the conclusion of the first duration terminating illumination of the first illumination device;
illuminating a second illumination device for another predetermined duration at the conclusion of the first duration,
timing the illumination of the first and second illumination devices so the first and second illumination device are synchronized to sequentially illuminate and so neither illumination device is illuminated during the same predetermined duration;
sequentially repeating illuminating the first and second illumination devices;
determining an intensity of the first and second illumination device;
comparing the determined intensity to a threshold; and
increasing intensity of one of the first and the second illumination device if the determined intensity is below the threshold.

43. The method of claim 42, further comprising illuminating first and second banks of light emitting diodes as the respective first and second illumination devices.

44. The method of claim 42, further comprising determining the intensity of the first and second illumination device by determining whether the first and the second illumination device is functioning.

45. The method of claim 42, further comprising terminating power to one of the first and the second illumination devices if the intensity is below the threshold.

46. The method of claim 42, further comprising illuminating white light.

47. The method of claim 42, further comprising sequentially repeating illuminating the first and second illumination devices at a frequency higher than a human eye can detect, the repetition being suitable so that the first and second illumination device appears to be constantly illuminated.

48. An apparatus comprising:
a first illumination device;
a second illumination device;
a logic unit connected to a switch and configured for illuminating the first illumination device for a first predetermined duration, and at the conclusion of the first duration terminating illumination of the first illumination device;
the logic unit further being configured for illuminating the second illumination device for another predetermined duration at the conclusion of the first duration;
the logic unit timing the illumination of the first and second illumination devices so the first and second illumination device is synchronized to sequentially illuminate and so neither illumination device is illuminated during the same predetermined duration;
the logic unit sequentially repeating illuminating the first and second illumination devices;
wherein the logic unit is connected to a first element, the first element is connected to at least one of the first and the second illumination devices;
wherein the logic unit develops a signal from the first element to determine an intensity of the first and second illumination devices;
wherein the logic unit comparing the intensity to a threshold stored in a memory; and
the logic unit is connected to a power supply and configured to increase intensity of at least one of the first and the second illumination devices if the intensity is below the threshold.

49. The apparatus of claim 48, further comprising a second element connected to the other of the first and the second illumination devices, wherein the logic unit develops the signal from the second element to determine the intensity of the first and second illumination devices.

50. The apparatus of claim 48, wherein the first illumination device is at least one light emitting diode.

51. The apparatus of claim 49, wherein the second illumination device is at least one light emitting diode.

52. The apparatus of claim 48, wherein the logic unit comprises a controller.

53. The apparatus of claim 48, wherein the first element is a resistor.

54. The apparatus of claim 49, wherein the second element is a resistor.

55. The apparatus of claim 48, wherein the threshold is an intensity being in a range that includes 800 to 1,000 Nits of brightness.

56. The apparatus of claim 48, wherein the threshold is an intensity being in a range that includes 400 to 500 Nits of brightness.

57. An apparatus comprising:
a first illumination device;
a second illumination device;
a logic unit connected to the first illumination device and the second illumination device;
wherein the logic unit is further coupled to a first element, the first element is connected to at least one of the first and the second illumination devices;
wherein the logic unit develops a signal from the first element to determine an intensity of the first and second illumination devices; and
wherein the logic unit is connected to a power supply and configured to increase intensity of at least one of the first and the second illumination devices if an intensity is below a predetermined threshold.

58. The apparatus of claim 57, wherein the first element is a resistor.

59. A computer-readable storage medium containing a set of program instructions for a computer having a user interface comprising a screen display, the set of program instructions comprising:
program instructions for illuminating a first bank of light emitting diodes in a first phase, and at the conclusion of the first phase terminating illumination of the first bank of light emitting diodes;
program instructions for illuminating a second bank of light emitting diodes for a second phase at the conclusion of the first phase, and
program instructions for timing the illumination of the first and second banks so the first and second banks are synchronized and so neither bank of light emitting diodes is illuminated during the same phase.
